(19) United States
(12) Patent Application Publication
(10) Pub. No.: US 2012/0233410 A1
(43) Pub. Date: Sep. 13, 2012

(54) Shared-Variable-Based (SVB) Synchronization Approach for Multi-Core Simulation

(75) Inventors: Cheng-Yang FU, Hsinchu City (TW); Meng-Huan Wu, Hsinchu City (TW); Ren-Song Tsay, Jhubei City (TW)

(73) Assignee: National Tsing Hua University, Hsinchu City (TW)

(21) Appl. No.: 13/046,743

(22) Filed: Mar. 13, 2011

(51) Int. Cl. G06F 12/08

(52) U.S. Cl. 711/141; 711/E12.026

(57) ABSTRACT

The present invention discloses a shared-variable-based (SVB) approach for fast and accurate multi-core cache coherence simulation. While the intuitive, conventional approach, synchronizing at either every cycle or memory access, gives accurate simulation results, it has poor performance due to huge simulation overloads. In the present invention, timing synchronization is only needed before shared variable accesses in order to maintain accuracy while improving the efficiency in the proposed shared-variable-based approach.

### TECHNICAL FIELD

This invention relates to a Shared-Variable-Based (SVB) synchronization approach for multi-core simulation, and more particularly for an approach to take advantage of the operational properties of cache coherence and to effectively keep a correct simulation sequence for a multi-core system.

### BACKGROUND OF RELATED ART

In order to maintain the memory consistency of multi-core architecture, it is necessary to employ a proper cache coherence system. For architecture designers, cache design parameters, such as cache line size and replacement policy, need to be taken into account, since the system performance is highly sensitive to these parameters. Additionally, software designers also have to consider the cache coherence effect while estimating the performance of parallel programs. Obviously, cache coherence simulation is crucial for both hardware designers and software designers.

A cache coherence simulation involves multiple simulators of each target core. As shown in FIG. 1(a), to keep the consistent simulated time 101 of each core, timing synchronization is required. A cycle-based synchronization approach synchronizes at every cycle as shown as in FIG. 1(b), and the context switch overhead 102 due to the frequent synchronization heavily degrades the simulation performance. At each synchronization point, the simulation kernel will switch out the executing simulator and put it in a queue according to the simulated time, and then switch in the ready simulator with the earliest simulated time to continue execution. Highly frequent synchronization causes a big portion of the simulation time spent on context switching instead of intended functional simulation.

As far as we know, existing cache coherence simulation approaches are making a tradeoff between simulation speed and accuracy. For instance, as shown in FIG. 2(a), event-driven approaches select system state changing actions as events 202 and keep these events 202 executed in a temporal order according to the simulated time instead of at every cycle. To execute events 202 in a temporal order, timing synchronization 203 is required before each event, as shown as in FIG. 2(b). While a correct execution order of events will clearly lead to an accurate simulation result, in practice not every action requires synchronization 203. If all actions are included as events without discrimination, the synchronization overhead can be massive.

As an example, since the purpose of cache coherence is to maintain the consistency of memory, an intuitive synchronization approach in cache coherence simulation is to do timing synchronization at every memory access point. Each memory operation may incur a corresponding coherence action, according to the type of memory access, the states of caches, and the cache coherence protocol specified, to keep local caches coherent.

To illustrate the idea, FIG. 3 shows how coherence actions work to keep local caches coherent in a write-through invalidate policy. When core_1 310 issues a write operation to the address @, the data of @ in memory 330 is set to the new value and a coherence action is performed to invalidate the copy of @ in local cache_2 321 of core_2 320. Therefore the tag of @ in local cache_2 321 of core_2 320 is set to be invalid. Next, when core_2 320 wants to read data from the address @, it will know that the local cache_2 321 is invalidated and that it must obtain a new value from the external memory.

Therefore, if timing synchronization is done at every memory access point, the cache-coherent simulation will be accurate. However, in general, over 30 percent of executed instructions of program are memory access instructions. Hence, this approach still suffers from heavy synchronization overhead.

To further reduce synchronization overhead in cache coherence simulation, a shared-variable-based (SVB) synchronization approach is disclosed in the present invention. As we know, coherence actions are applied to ensure consistency of shared data in local caches. In parallel programming, variables are categorized into shared and local variables. Parallel programs use shared variables to communicate or interact with each other. Therefore, only shared variables may reside on multiple caches while local variables can only be on one local cache. Since memory accesses of local variables cause no consistency issue, the corresponding coherence actions can be safely ignored in simulation. Based on this fact, to synchronize only at shared variable accesses can achieve better simulation performance while maintaining accurate simulation results.

### SUMMARY

The present invention discloses a Shared-Variable-Based (SVB) synchronization approach (hereinafter called SVB synchronization approach) for multi-core simulation. The SVB synchronization approach of the present invention makes cache coherence simulation efficiently for a multi-core system.

A SVB synchronization approach for multi-core simulation includes a parallel program running on a multi-core system. The multi-core system includes an external memory and a plurality of cores, and every core has its own local cache. The parallel program includes a plurality of simulators and each simulator runs on an individual core and is responsible for a specific simulation task. Hence, the correct timing synchronizations and the coherence actions are essential during simulation.

In general, a parallel program includes a plurality of local variables and a plurality of shared variables. Only residing on one local cache, the local variables will not cause inconsistency during memory accesses. Therefore, the corresponding coherence actions and the consistency check of the local variables can be ignored in simulation. Shared variables reside on multiple local caches and are used to communicate or interact with each other, so coherence actions are only applied on the shared variables to ensure consistency. Since only shared variables are needed to be synchronized during simulation, not only the simulation speed but also the accuracy can be achieved for a multi-core simulation.

In one embodiment, a multi-core system includes at least two cores, a first core and a second core. During simulation, the first core issues an invalidation signal when a write operation is executed in the local cache of the first core. The invalidated signal issued by the first core occurs between two read operations, a first read and a second read, performed in the local cache of the second core, and then a coherence action handling will be executed while the second core carries out the second read operation.

In one embodiment, the name of a specific function (i.e., the shared-variable-allocation function) is used to identify the address of a shared variable used in parallel programs, and the returned value of the specific function is the address of a shared variable. The specific function also generates a calling address after compiling a parallel program.

In one embodiment, the multi-core system further includes a scheduler, such as SystemC kernel, to queue and re-schedule a timing synchronization and coherence action. While a parallel program with multiple simulators runs on a multi-core system, an individual simulator running on an individual core submits a coherence action and a shared memory access event to the scheduler. After that, the scheduler achieves the timing synchronization and coherence actions by calling the wait function (i.e., wait( )).

When executing the wait function, the scheduler will switch out the calling simulator and switch in another particular simulator depending on the calculation of the invocation time according to the wait time parameter of the wait function.

In one embodiment, to improve simulation efficiency, the handling of coherence actions on each single-core simulator can be deferred until encountering a shared memory access point. The coherence actions have to be queued up before the memory access point and only to be executed when a shared memory access point is reached. In other words, all coherence actions have to occur before a shared memory access point is captured in the queue for processing.

### BRIEF DESCRIPTION OF THE DRAWINGS

The above objects, and other features and advantages of the present invention will become more apparent after reading the following detailed description when taken in conjunction with the drawings, in which:

FIG. 1(a) illustrates the simulated time of each core is consistent with cycle-based approach.

FIG. 1(b) illustrates timing synchronization is done at every simulation cycle.

FIG. 2(a) illustrates events are executed in a temporal order.

FIG. 2(b) illustrates timing synchronization is done before every event.

FIG. 3 shows a two-core system executes cache coherence based on a write-through invalidate policy.

FIG. 4(a) illustrates core_1 issues a write operation between two read operations in core_2.

FIG. 4(b) illustrates without keeping the execution order, the read 2 operation of core_2 gets the old value.

FIG. 5 illustrates after compilation, shared variables can be identified through the shared-variable-allocation function.

FIG. 6 illustrates the proposed simulation framework for a multi-core with cache coherence.

FIG. 7(a) illustrates core_0 is processing synchronization at shared memory access R2.

FIG. 7(b) illustrates after synchronization, the coherence actions received between from time of R1 to R2 are queued first.

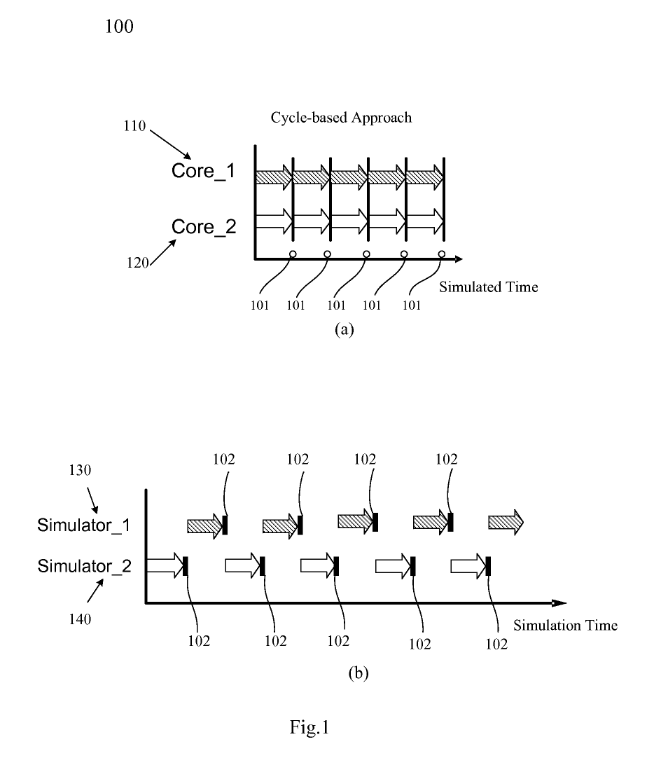

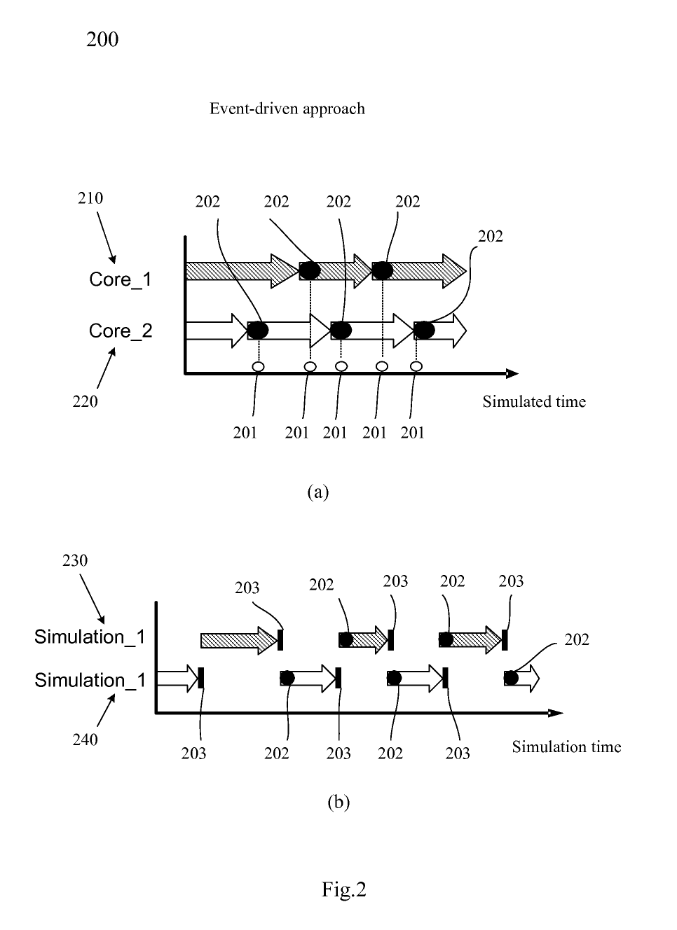

### DETAILED DESCRIPTION

The method of a Shared-Variable-Based (SVB) synchronization approach (hereinafter called SVB synchronization approach) for multi-core systems is described below. The SVB synchronization approach of the present invention is very efficient for cache coherence simulation in multi-core systems. In the following description, more detail descriptions are set forth in order to provide a thorough understanding of the present invention and the scope of the present invention is expressly not limited expect as specified in the accompanying claims.

To effectively reducing synchronization overhead in multi-core simulation, it resides in the fact that only shared variables in local caches can affect the consistency of cache contents. Therefore, timing synchronizations are needed only at shared variable access points in order to achieve accurate simulation results.

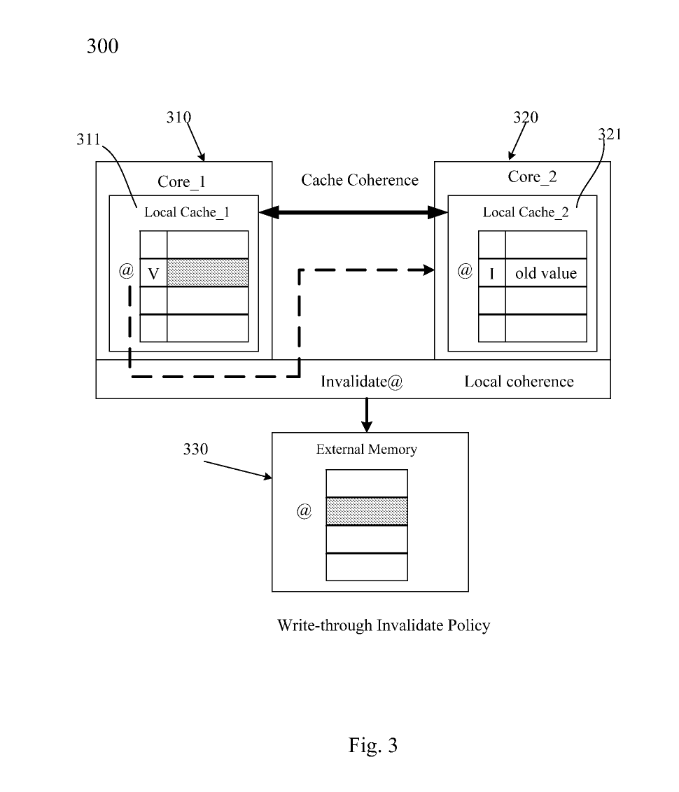

As shown in FIG. 3, a two-core system 300 includes two processor cores (core_1 310 and core_2 320) and an external memory 330. The core_1 310 and the core_2 320 have their individual local caches, local cache_1 311 and local cache_2 321, respectively. In cache coherence simulation, it is crucial to know the correct execution order of data access and coherence actions in each cache. A parallel program will use shared data to interact with each other, and these shared data may have multiple copies in different local caches on a multi-core system. The correct simulation procedure of cache update coherence actions is essential to maintaining correct cache contents and states of caches without simulation corruption.

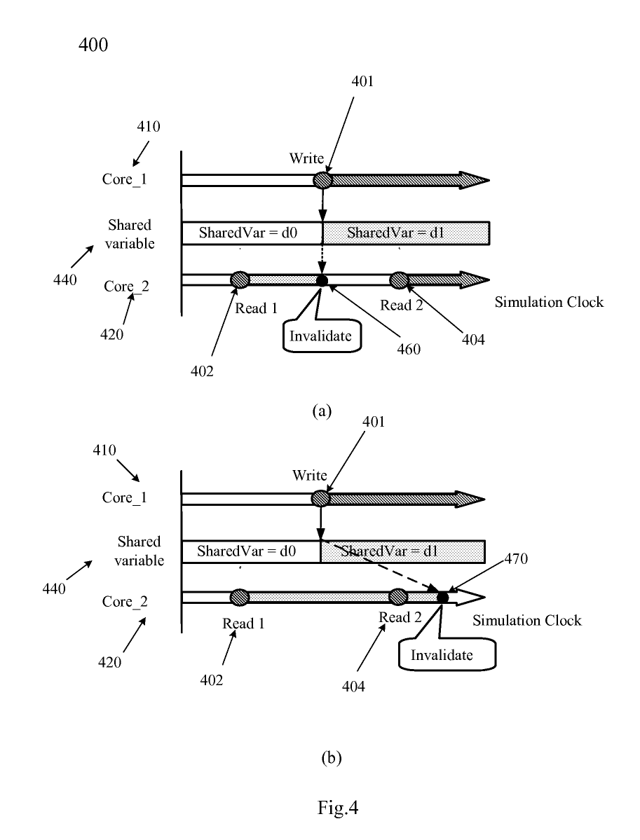

In one embodiment, as shown in FIG. 4, the importance of correct simulation order of data access and coherence actions is illustrated. Core_1 410 and Core_2 420 have their individual local cache, and a shared data stored in the two caches has to keep consistency. FIG. 4(a) is a correct simulation of shared data accesses in a cache coherence system. Core_1 410 executes the write operation 401 between the first read operation (read 1) 402 and the second read operation (read 2) 404 of core_2 420. The write operation 401 of core_1 changes the value of the shared variable 440 in core_1's local cache from d0 to d1. However, the value of the shared variable 440 in core_2's local cache remains d0 instead of d1. Therefore, the time to execute the invalidation caused by the write operation of core_1 410 is important because it forces the second read operation 404 of core_2 to re-read data from memory instead of cache so as to keep the consistency between two local caches. As shown in FIG. 4(b), owing to the invalidation operation 470 not being captured between the firs read operation 402 and the second read operation 404, the second read operation 404 reads the wrong value (d0) and changes the behavior of core_2. Clearly, improper execution orders can generate inaccurate simulation results.

Theoretically, for minimum synchronization overhead, the execution order of the coherence actions and data accesses in cache locations that point to the same shared variable address need to be maintained properly. However, due to the large memory space required for recording the necessary information, it is infeasible to trace addresses of all coherence actions and data accesses.

In one embodiment, a proper method is to synchronize at every shared variable access point. Coherence actions are used to mark cache status and ensure the consistency of shared data in local caches. Since only shared variables may reside on multiple caches and local variables can only be on one local cache, memory accesses of local variables cause no consistency issues. Hence, the corresponding coherence actions can be safely ignored in simulation. Therefore, in one embodiment, synchronization is only executed at shared variable access points to achieve accurate simulation results with high simulation performance.

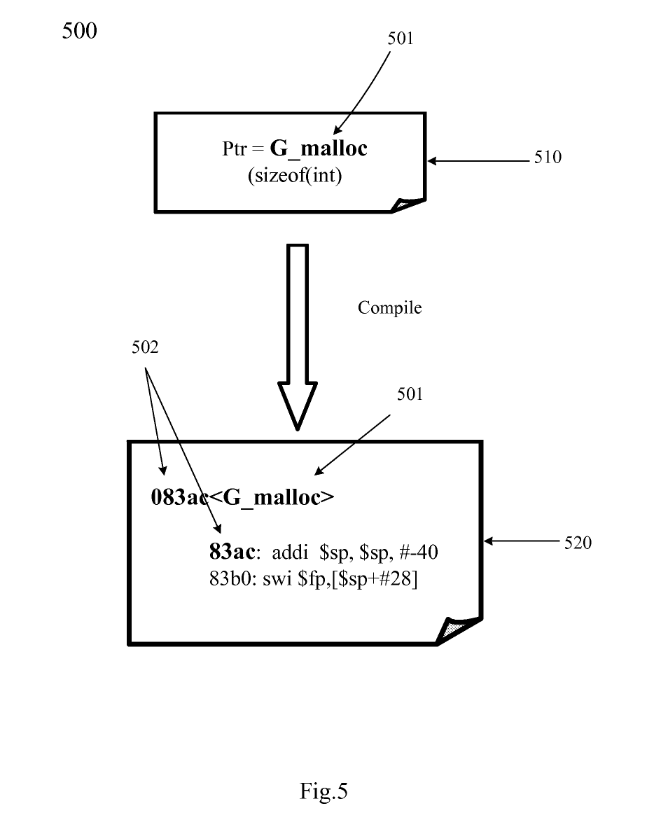

In one embodiment, the multi-core simulation is used to elaborate SVB synchronization approach of the present invention. In a multi-core platform, each core is simulated by a single target-core simulator and coherence actions are passed between simulators. Depending on programming language semantics or multi-core architectures, there are different ways for indentifying shared variables. Because the shared variables used in parallel programs normally are created by a specific function (i.e., shared-variable-allocation function), the name of shared-variable-allocation function may be used as one possible way to identify the address of shared variables used in parallel programs. The returned value of this specific function is the address of shared variables. After compilation, the calling address of the allocation function according to the function name can be obtained. As shown in FIG. 5, the function address (083ac) 502 of the shared-variable-allocation function (i.e., G_malloc) 501, can be obtained after compilation. Then, during simulation, if the target address of a function jump instruction is exactly that of G_malloc 501, then the returned value of the function is identified as a shared variable address.

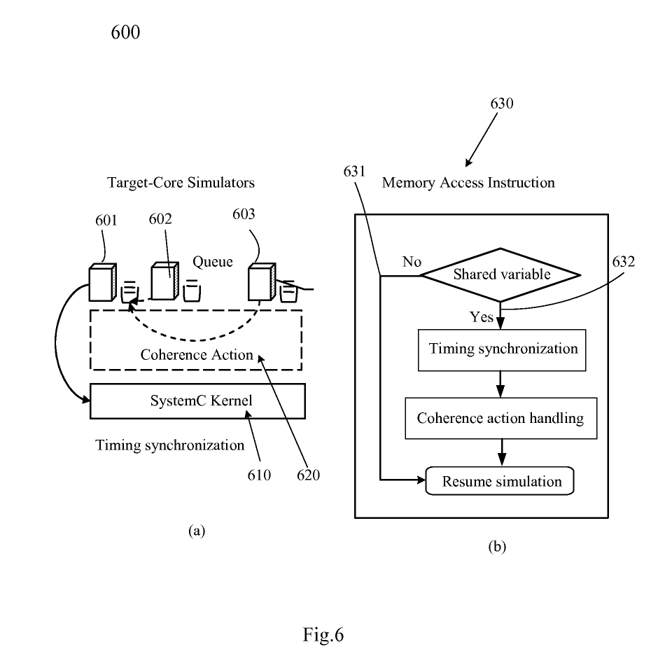

In one embodiment, a proposed simulation flow is described in detail based on the simulation framework shown in FIG. 6. As discussed before, for achieving accurate simulation results, it needs to make sure that all unprocessed coherence actions have occurred before any shared variable memory access instruction are processed prior to executing the memory access. One intuitive approach for ensuring the temporal execution order of both coherence actions and shared variable memory access instructions is to perform timing synchronization on all coherence action and shared memory access points.

In one embodiment, the idea is implemented using the platform shown in FIG. 6(a), each single-core simulator 601 602 603 submits its broadcasted/received coherence actions and shared memory access events to SystemC kernel 610 and lets the kernel's internal scheduling mechanism perform timing synchronization. In SystemC, timing synchronization is achieved by calling the wait( )function. When executing wait( ), the SystemC kernel 610 will switch out the calling simulator and calculate the invocation time according to the wait time parameter of the wait( ) function. Then, the SystemC kernel 610 selects the queued simulator 601 602 603 with the earliest simulated time to continue simulation.

In one embodiment, as shown in FIG. 6(a), to improve simulation efficiency, the handling of coherence actions 620 on each single-core simulator can be deferred until encountering a shared memory access point. For accuracy, all coherence actions occurred prior to a shared memory access must be processed before the memory access point. There are two important considerations associated with this requirement. First, these coherence actions 620 only have to be executed before the memory access point, but not necessary at the action occurring time. Therefore, it just needs to queue up the coherence actions and process them when a shared memory access point is reached. By doing so, the overhead is greatly reduced. Then, it needs to ensure that all coherence actions occurring before a shared memory access point are captured in the queue for processing. The above-mentioned requirement is in fact guaranteed by applying the centralized SystemC kernel scheduler. Note that after timing synchronization, the simulator with the earliest simulated time is selected to continue execution. In this way, the coherence actions broadcasted from other simulated cores must have occurred before the current time point and all related coherence actions should have been captured.

In one embodiment, given that the communication delay for passing coherence actions is fixed, then the queued coherence actions should be naturally in temporal order since the simulators are invoked following the temporal order of shared memory access points through the centralized SystemC kernel scheduler, as discussed before.

In one embodiment, in cases where the communication delay to different cores is uncertain, the received coherence actions may not be in the proper temporal order. Therefore, the coherence actions queue will be put into temporal order before processing them. With synchronizations only at shared memory access points and all required coherence actions ready in queues, the simulation approach not only performs much more efficiently than the prior art but also guarantees functional and timing accuracy.

In one embodiment, as shown in FIG. 6(b), when a parallel program is being simulated in the platform shown in FIG. 6(a), once a memory access instruction is executed, the SVB synchronization approach of the present invention will first judge whether the accessing data is a shared variable. Given that the answer is “No” 631, the parallel will resume the simulation. On the contrary, if the answer is “Yes” 632, the SVB synchronization approach will do timing synchronization and coherence action handling in order and then resume the simulation.

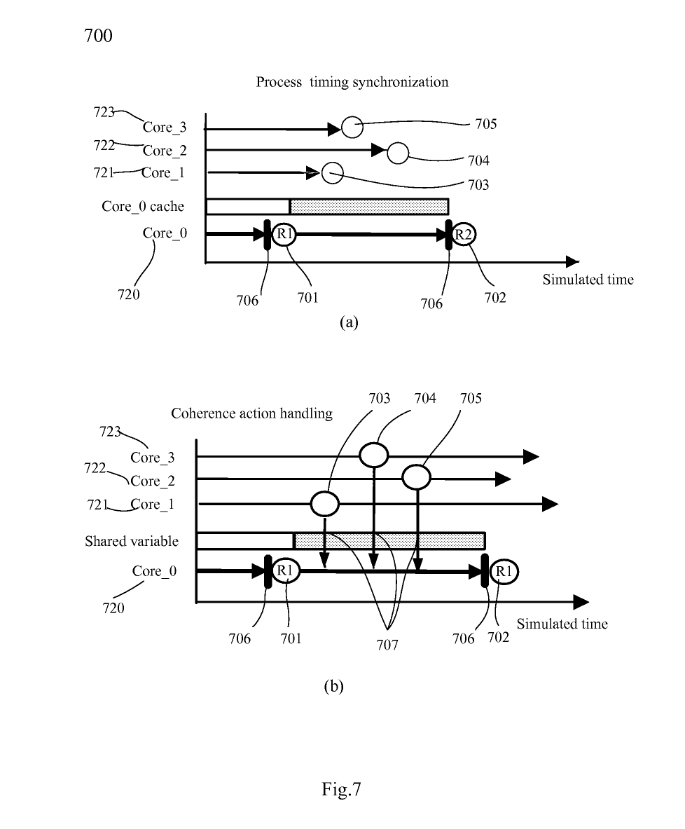

In one embodiment, with synchronizations only at shared memory access points and all required coherence actions ready in queues, the simulation approach not only performs much more efficiently than prior arts but also guarantees functional and timing accuracy. As shown in FIG. 7(a) the timing synchronization event 706 is inserted before every shared variable memory access point, i.e., R1 701 and R2 702. The simulator process of core_1 721, core_2 722, and core_3 723 is going to reach the shared memory access points 703 704 705, respectively. Assume that the simulator core_0 720 is processing synchronization at shared memory access point R2 702. Since the targets (core_0's cache) of R1 701 and R2 702 are the same, the data is in the cache of core_0 720 already. Then, core_0 720 is invoked from synchronization; its time will be the earliest as shown in FIG. 7(b). The queued coherence actions 707 between the time of R1 701 and R2 702 are processed first before execution of shared memory read R2 702. Those coherence actions will update the state or the data of the local cache. Following this proper processing sequence, we are guaranteed to have accurate simulation results are guaranteed.

Although preferred embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. A Shared-Variable-Based (SVB) synchronization approach for multi-core simulation comprising:
a multi-core system containing an external memory and a plurality of cores, wherein each said core has a local cache;
a parallel program containing a plurality of local variables and a plurality of shared variables, and running on said multi-core system; and
only said shared variables residing on said local caches of said multi-core system require a timing synchronization and coherence action during simulation.

2. The SVB synchronization approach according to claim 1, wherein said parallel program comprises a plurality of simulators for different simulation tasks.

3. The SVB synchronization approach according to claim 2, wherein each said simulator is run on each said core.

4. The SVB synchronization approach according to claim 2, wherein said parallel program uses said shared variables to interact between said simulators.

5. The SVB synchronization approach according to claim 1, wherein said shared variables residing on said local caches have to keep coherence for simulation accuracy.

6. The SVB synchronization approach according to claim 1, wherein said local variables residing on said local caches need not to keep consistency so as to speed up the simulation.

7. The SVB synchronization approach according to claim 1, wherein said multi-core system comprising at least two cores, a first core and a second core.

8. The SVB synchronization approach according to claim 7, wherein said timing synchronization and coherence action comprises issuing an invalidation signal and executing a coherence action handling.

9. The SVB synchronization approach according to claim 8, wherein said invalidation signal is issued by said first core when a write operation is executed in said local cache of said first core between two read operations, a first read and a second read, occurred in said local cache of said second core.

10. The SVB synchronization approach according to claim 9, wherein said coherence action handling is executed before said second core executes said second read operation.

11. The SVB synchronization approach according to claim 1, wherein said shared variables used in said parallel program are created by a shared-variable-allocation function.

12. The SVB synchronization approach according to claim 11, wherein said shared-variable-allocation function returns an address of said shared variable.

13. The SVB synchronization approach according to claim 11, wherein said shared-variable-allocation function generates a calling address after compiling said parallel program.

14. The SVB synchronization approach according to claim 13, wherein said calling address is used to identify said shared-variable-allocation function in a compiled parallel program during simulation.

15. A Shared-Variable-Based (SVB) synchronization approach for multi-core simulation comprising:
a multi-core system containing an external memory and a plurality of cores, wherein each said core has a local cache;
a parallel program containing a plurality of local variables and a plurality of shared variables, and running on said multi-core system;
a scheduler queuing and re-scheduling a plurality of timing synchronization and coherence actions during simulation; and
only said shared variables residing on said local caches of said multi-core system require said timing synchronization and coherence action during simulation.

16. The SVB synchronization approach according to claim 15, wherein said parallel program comprising a plurality of simulators runs on said multi-core system.

17. The SVB synchronization approach according to claim 16, wherein each said simulator running on said core submits a coherence action and a shared memory access event to said scheduler.

18. The SVB synchronization approach according to claim 15, wherein said scheduler performs said timing synchronization and coherence action by calling a wait function.

19. The SVB synchronization approach according to claim 18, wherein said wait function allows said scheduler to switch out one of said simulators and to execute another said simulators correctly.

20. The SVB synchronization approach according to claim 17, wherein said coherence action has to be executed before a memory access point.
